(19) United States
(12) Patent Application Publication
(10) Pub. No.: US 2008/0140506 A1
(43) Pub. Date: Jun. 12, 2008

(54) Systems and methods for the identification, recruitment, and enrollment of influential members of social groups

(75) Inventors: Alfred Christianson, Roswell, GA (US); Steve Levin, Cincinnati, OH (US); Janelle Hansen Zurek, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Corporation

(21) Appl. No.: 11/636,109

(22) Filed: Dec. 8, 2006

(51) Int. Cl. G06Q 30/00

(52) U.S. Cl. 705/10; 705/14

(57) ABSTRACT

Systems and methods for the identification, recruitment, enrollment, and scoring of influential members of social groups are provided. One or more consumer events is monitored and analyzed by an event server. Data from these consumer events is then passed through standard and custom event models. Using these event models, a holistic social networking score is computed for each consumer using a set of standard and custom scoring rules. The holistic score may be used to compare individual consumers within a target market group and create a consumer marketing panel with a high degree of social networking value. The consumer marketing panels may then be segmented and used in various marketing campaigns. Value assessments for consumers may be validated and refined continuously or periodically using participation data from a series of artificial or actual marketing campaign events.

### FIELD OF THE INVENTION

This invention relates generally to peer to peer marketing campaigns, and, more particularly, to systems and methods for the identification, recruitment, and enrollment of influential members of social groups for use in peer based marketing campaigns.

### BACKGROUND OF THE INVENTION

Word of mouth (“WOM”), or interpersonal communication, may come in many forms, including personal recommendations, testimonials, and gossip. WOM often spreads through various social ties between members of a social group. Some of these ties may be strong ties (e.g., the social ties between close friends), where WOM may spread freely and quickly. Other ties may be relatively weak ties (e.g., the social ties between co-workers), where WOM may spread more slowly and may be met with reservation. In the marketing realm, there is little doubt that WOM spread through strong social ties is extremely valuable to the successful launch of a new product or service or growth of an existing product or service, though WOM spread through weak social ties is not without value.

Not all social group members, however, have equal propensity to generate positive WOM or to influence the purchasing decisions of other members of the social group. For example, some highly-influential members of a social group, sometimes referred to as “influencers” or “connectors,” may have wider social circles and greater powers of persuasion than other social group members. These influential social group members may also derive personal satisfaction from being perceived as thought leaders in their area of interest.

Because of their ability to influence the purchasing decisions of other social group members, the identification and recruitment of influencers is highly desirable to marketing professionals for use in marketing campaigns. Influencers are also particularly valuable to marketers because they may rapidly accelerate the adoption of new products or ideas, either prior to or after entry into the market place. Marketing campaigns that utilize influencers are often called WOM marketing campaigns, social marketing campaigns, peer to peer marketing campaigns, or viral marketing campaigns. As described in more detail in commonly-assigned U.S. patent application Ser. No. 11/508,031, filed Aug. 21, 2006, which is hereby incorporated by reference herein in its entirety, influencers may be used to predict the efficacy of a marketing message to generate positive WOM. Influencers may also be used to refine marketing messages to maximize its WOM potential. Although the overall efficacy of any given marketing campaign and/or marketing campaign component is the result of a combination of many factors, the efficacy of a WOM, social, or viral marketing campaign is in large part attributed to the number and quality of influencers utilized within the campaign. Thus, all else being equal, a WOM, social, or viral marketing campaign that uses a larger number of highly-capable influencers will be more successful than a marketing campaign that uses fewer influencers (or influencers with less potential).

Accurately assessing a given influencer's potential, however, is often difficult due to the quality of the information generally possessed about a given individual within a social group. Information about potential influencers that is provided by the potential influencers themselves, for example, may misrepresent the actual degree of one or more influencer traits. Such misrepresentation may be intentional or inadvertent, and could understate or overstate the potential influencer's ability to actually influence other social group members. In addition, some of the information used to evaluate influencers may be based on interpersonal or electronic forms of interaction with other social group members (e.g., Internet-based interactions), which may be extremely difficult to monitor and evaluate.

Accordingly, it would be desirable to provide more reliable systems and methods for accurately identifying, recruiting, enrolling, and scoring influencers within a target demographic group or social network. These influencers may then be used in a given marketing campaign effort to improve the efficacy and efficiency of the campaign and its ability to generate positive WOM about a product or service.

### SUMMARY OF THE INVENTION

In accordance with principles of the present invention, systems and methods for the identification, recruitment, enrollment, and scoring of influential members of social groups are provided. A potential influencer is first identified and screened through an influencer screening component. In some embodiments, this screening component includes a webpage with at least one electronic survey to be completed by the potential influencer. The electronic survey may include socio-demographic questions as well as questions relating to consumer behavior, such as spending and purchasing habits. The survey may also include one or more questions relating to the potential influencer's ability to influence other members of the potential influencer's social group. In other embodiments, this screening component may rely on observed behavior rather than information provided explicitly by the potential influencer. In still other embodiments, screening may occur at a point-of-sale (POS) system, kiosk, over the telephone, through traditional direct postal mail, through email, or through text (e.g., SMS, MMS) or instant messaging (IM) services.

Information relating to the screening event and the potential influencer may then be sent to a scoring engine. In response to completing the influencer screening component, one or more initial influencer trait scores may be computed for the potential influencer. These one or more initial influencer trait scores may be derived from information obtained or observed via the influencer screening component as well as information obtained from external sources of information (e.g., information provided by a marketer or other third party). The one or more influencer trait scores may relate to projected or anticipated levels of one or more influencer traits associated with the potential influencer. Based on the one or more initial influencer trait scores, the potential influencer may be rejected or enrolled as an influencer. If the potential influencer is rejected, no notification may be given, or the potential influencer may be directed to a third-party website (or sent information from a third-party). If the potential influencer is enrolled, the scoring engine may add the enrolled influencer and the screening event details to a scoring database. In some embodiments, an influencer tier level (e.g., tier 1, tier 2, or tier 3) may also be associated with the enrolled influencer.

After an influencer is enrolled, one or more of the influencer's initial influencer trait scores may be validated or refined. In some embodiments, the initial influencer trait scores may relate to one or more of the influencer traits of longevity, recency, participation, and diffusion. To validate or refine the initial influencer trait scores associated with an influencer, one or more marketing campaigns may be created. These marketing campaigns may be actual marketing campaigns pertaining to real products or services or artificial marketing campaigns pertaining to mock products or services. The marketing campaigns may be specifically created to obtain more information about the potential influencer and to refine or validate the influencer trait scores associated with the influencer through the observation of influencer behavior. In some embodiment, the observation of influencer behavior includes assessing an influencer's level of participation in one or more of the marketing campaigns.

After a marketing campaign is created, an event notification message may be delivered to the influencer. The event notification message may include an invitation to participate in the actual or artificial marketing campaign. The invitation may also include a link to the marketing campaign or other information in support of the campaign. The invitation and event notification message may be delivered to the influencer in a variety of ways, including, for example, via email, Instant Message (IM), text message, telephone call, or traditional direct postal mail. In some embodiments, event notifications are delivered to influencers by interactive overlays or prompts on a POS terminal, kiosk, or television. An event server monitors all influencer event activity and provides this information to the scoring engine. Based on information observed or derived from the influencer event activity, influencer trait scores associated with the influencer may be validated or refined. Influencer trait scores may be continuously or periodically refined even further using one or more subsequent marketing campaigns.

In one embodiment, a computer program running on a processor is provided for identifying, recruiting, enrolling, and scoring influential members of social groups. The computer program includes program logic configured to solicit and enroll social group members as influencers. The program logic may also be configured to send marketing campaign event notifications to groups of influencers meeting a pre-defined criteria. The program logic may then receive marketing event interaction information from the event server and calculate or refine at least one influencer trait score for each influencer in the group of influencers. The program logic may further be configured to periodically send additional marketing campaign event notifications to the group of influencers to further refine the influencers' influencer trait scores. In some embodiments, the influencer trait scores may relate to one or more of the influencer traits of longevity, recency, participation, and diffusion.

### BRIEF DESCRIPTION OF THE DRAWINGS

FIG. 1 is block diagram of an illustrative network topology in accordance with the present invention;

FIG. 2 shows an illustrative influencer identification timeline in accordance with the present invention;

FIG. 3 shows an illustrative influencer scoring process in accordance with the present invention;

FIG. 4 shows illustrative influencer scoring tables in accordance with the present invention;

FIG. 5 is an illustrative process for identifying, recruiting, and enrolling influencers in accordance with the present invention;

FIG. 6 is an illustrative process for screening and scoring potential influencers in accordance with the present invention;

FIG. 7 is an illustrative process for validating and refining the recency influencer trait score associated with an influencer in accordance with the present invention;

FIG. 8 is an illustrative process for validating and refining the diffusion influencer trait score associated with an influencer in accordance with the present invention; and

FIG. 9 is an illustrative process for creating a consumer marketing panel in accordance with the present invention.

### DETAILED DESCRIPTION OF THE INVENTION

Embodiments of the present invention relate to systems and methods for identifying, recruiting, enrolling, and scoring influential members of social groups. The results of the present invention are useful in determining the interest and ability of individuals belonging to one or more social groups to influence other members of those, or other, social groups. In the marketing realm, the ability to influence other social group members is an important indicator of the ability to affect awareness of, interest in, or the probability of purchasing various goods and services. Reliably identifying influential members of social groups, therefore, is extremely valuable to marketing professionals.

As described in more detail below, highly-influential individuals within a social group are referred to herein as “influencers” or “connectors.” Influencers may include highly-connected individuals (e.g., individuals with a large number of social ties) within one or more social groups who are likely to share ideas with other social group members. In terms of the present invention, influencers possess a high degree of one or more influencer traits when compared to other social group members. Influencer traits may include, for example: 1) longevity, or an indication of how long the influencer has been enrolled as an influencer; 2) recency, or an indication of how recently the influencer has performed a significant activity; 3) participation, or an indication of how often the influencer participates in influencer activities (i.e., marketing campaign events); and 4) diffusion, or an indication of how well the influencer relays information to other members of the influencer's social group. Additional influencer traits may be defined in other embodiments. An influencer trait “score” is the quantification of the degree an influencer possesses a given influencer trait. Influencer trait scores may include relative scores (e.g., scores relative to other members of the influencer's social group or groups—e.g., percentile or decile values), absolute scores, or composite scores, as described in more detail below.

As used herein the term “social group” refers to any group of individuals connected by direct and/or indirect personal, social, familial, commercial and/or professional relationships. Such social groups may include, without limitation, nuclear and extended families, groups of friends, professional organizations, and coworkers. These relationships may be temporary in duration (e.g., people at a party), of intermediate duration (e.g., people working or socializing for a finite, multi-day period such as a work project or vacation), or of an indefinite duration (e.g., coworkers or neighbors). The connections and relationships within the social group may vary in intensity (e.g., weak, mild, strong, intense) as well as the degree of importance to the social group member (e.g., high, medium, or low). It will also be understood that within the social group may exist one or more subgroups, and that individuals within a larger subgroup may have numerous types of relationships with different members of the various subgroups.

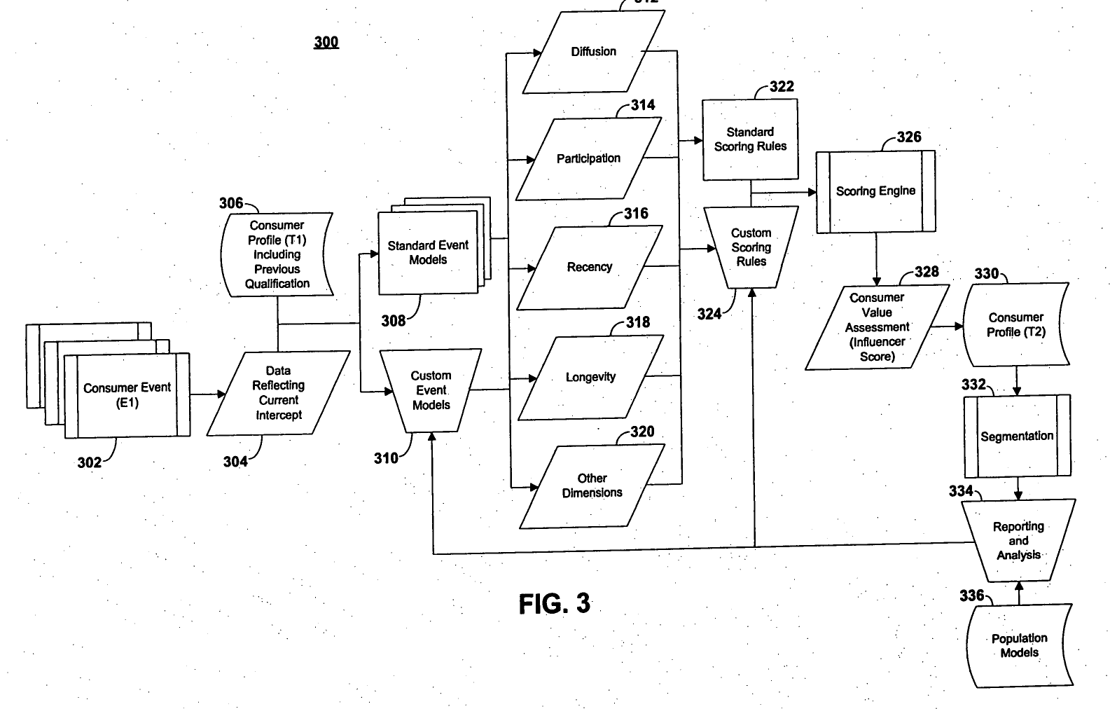

Validation of an influencer trait score associated with an influencer is performed through a series of actual or artificial campaign “events.” Campaign events in accordance with the present invention may include any interaction performed by a social group member (or a friend of a social group member), such as participating in a survey, reading an email, visiting a website, mailing in a return postcard, or any other activity. It is to be expressly understood that some user interactions may be online interactions (e.g., interactions that take place, at least in part, over the Internet or other private or public network) and some interactions may be offline interactions (e.g., interactions via direct postal mail). Influencer trait scores may be monitored, validated, and/or refined periodically or continuously through participation in a number of campaign events, as described in more detail below with regard to FIGS. 3-8.

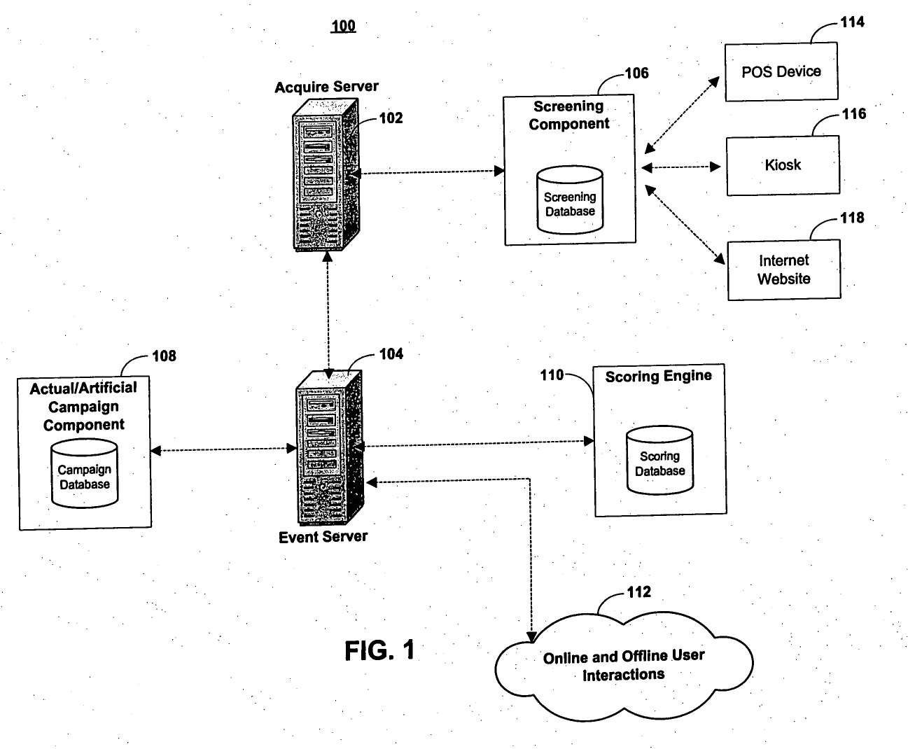

FIG. 1 shows illustrative network 100 in one embodiment of the invention. Network 100 includes acquire server 102 and event server 104. Acquire server 102 and event server 104 may be any computing device, networked computer, or server with data processing capabilities. Acquire server 102 and event server 104 may include one or more processors, memory (e.g., RAM, ROM, and/or hybrid types of memory), storage devices (e.g., hard drives, tape drives, optical drives) and various network connections. For example, acquire server 102 and event server 104 may include one or more network interface cards (NICs) to connect to one or more public or private networks (such as the Internet). Acquire server 102 and event server 104 may also host one or more webpages, websites, or other web services, or non-web services, including but not limited to manual entry data systems, call center systems, or point-of-sale (POS) systems. Although acquire server 102 and event server 104 are shown as two separate elements in the example of FIG. 1, in actual implementations their functionality may be combined into a single server, computer, or process.

Acquire server 102 may be primarily responsible for recruiting and enrolling new influencers. New influencer may be recruited in a number of ways. For example, a potential influencer may access screening component 106 over a public or private network (e.g., the Internet), at an in-store kiosk, over the telephone, or using any other suitable mechanism. In some embodiments, screening component 106 includes a traditional paper mailing to social group members. In other embodiments, screening component 106 may include an electronic survey hosted via one more webpages. In some embodiments, participants may be actively recruited to participate in screening component 106. For example, direct mail or email invitations may be sent to selected consumers meeting predefined criteria. The invitation may include a link to access screening component 106 or screening may be facilitated by a moderator and, optionally, a user access code to help identify the consumer.

Consumers may also be recruited while in a store, at a checkout counter, over the telephone, or via electronic message (e.g., IM, text message, or email message). For example, kiosk 116 may include at least one interactive terminal that is strategically positioned within a retail location. In some embodiments, the interactive terminals may display targeted advertising related to a promotional product or service while the terminals are not in use. The targeted advertising may also be tailored to the desired target market group (e.g., teens or moms). Consumers may approach an interactive terminal at kiosk 116 in order to participate in screening component 106, or for some other suitable purpose. The user may interact with the terminal using an attached keyboard, touch screen, or via a voice recognition module. Incentives (e.g., coupons, rebates, store credit, cash, sweepstakes entries) may also be offered to consumers in order to encourage participation in screening component 106.

As another example, consumers may be recruited to participate in screening component 106 at POS device 114, such as a staffed or automated checkout terminal or cash register. A list of predefined products or services may be stored in a database at POS device 114. When a consumer purchases or inquires about a product or service listed in the database, an invitation to participate in screening component 106 may be presented to the consumer. The products or services included in the database may be individually selected by the marketer. Alternatively or additionally, a brand (e.g., Tide) or a product type (e.g., laundry detergent) may be included in the database to match all products of that brand or product type.

The targeted consumer may either provide contact information at POS device 114 and participate in screening component 116 at a later time or participate in screening component 116 while at POS device 114. If only contact information is provided, an invitation to complete screening component 106 may be delivered to the consumer using the provided contact information. For example, the user may provide an email address or telephone number as the user's contact information and an email or voice invitation may be delivered to the email address or telephone number at a later time. The user may open the email invitation and select a link to access screening component 106. If screening component 106 is to be completed while at POS device 114, the consumer may interact with an interactive terminal attached to or integrated with POS device 114. The interaction may occur via any available input device (e.g., a touch screen, keyboard, or voice recognition module, or human facilitator).

As another example, consumers may be recruited for participation in screening component 106 while visiting Internet website 118. There are numerous ways a consumer may be recruited for participation in screening component 106 while online (i.e., while connected to the Internet or other private or public network). For example, an individual may initiate a search for information by submitting an information request to an information search system, database, or search engine. Suitable search systems may include any number of proprietary or public searching systems, or combinations thereof, including computer-enabled searching systems, such as those available over computer networks, including the Internet.

Suitable proprietary networks could include information databases such as Lexis-Nexis®, Dunn and Bradstreet®, and the like, that may be available over the public Internet or through proprietary connections. Suitable public searching systems could include any number of Internet search engines, such as Google®, Yahoo®, and the like, that search Internet content and display search results. Regardless of the type of information search, a user may submit an information request containing keywords, phrases, or search terms. The information request may then be compared with a predefined list of information terms stored in a database or other storage mechanism. The predefined list of information terms may include one or more words, terms, and/or phrases that an individual may use to identify, search, or locate information. The information terms may be formatted for the specific information search engine or be unformatted as plain or parsed text. The information terms may include the terms selected and used by the individual to search for the information, or may additionally or alternatively be the terms used to describe the information the individual is seeking, generated prior to or concurrently with the delivery and/or display of the information search result.

The information request submitted by the individual may then be compared against the predefined list of information terms. The comparison may be performed on words, letters, phrases, symbols, or any other suitable unit of the information request that is capable of being parsed. If the comparison determines that the information request matches a term in the predefined list of information terms (optionally within an acceptable margin of error or distance), then the results of the information request are provided to the individual along with an invitation to participate in screening component 106. For example, the results of the information request may be presented in one page, frame, window, or application and the invitation may be presented in another. The invitation may also be displayed simultaneously with the results of the information request (e.g., adjacent to the results) in a single page, frame, window, or application if desired. It should be understood that the generation and display of the invitation does not have to occur with the generation and/or display of the information request results, but may occur at a subsequent point in time. It will also be understood that the invitation and the information request results may be provided in different formats or through different transmission mechanisms or channels. For example, the information request results may be presented by Internet website 118, while the invitation is delivered via postal mail, voice mail, IM, or text message to the individual.

It should be noted that, in some embodiments, potential influencers may be recruited for participation in screening component 106 not only based on explicit behaviors such as those described above, including specific purchases made or searches executed, but also based on implicit behaviors such as the variety and type of systems accessed (e.g., proprietary or public databases and search systems), locations visited (e.g., retail stores and entertainment facilities), media observed (e.g., television and print), or other suitable and observable behaviors, and the order and duration of these behaviors.

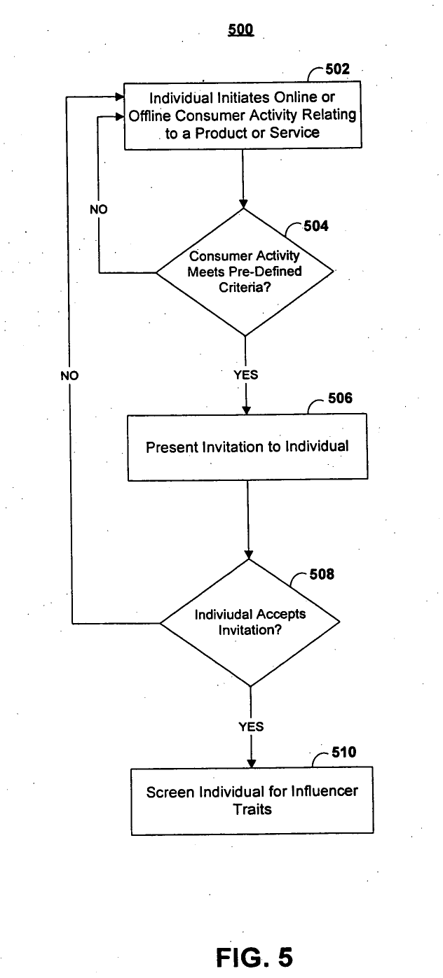

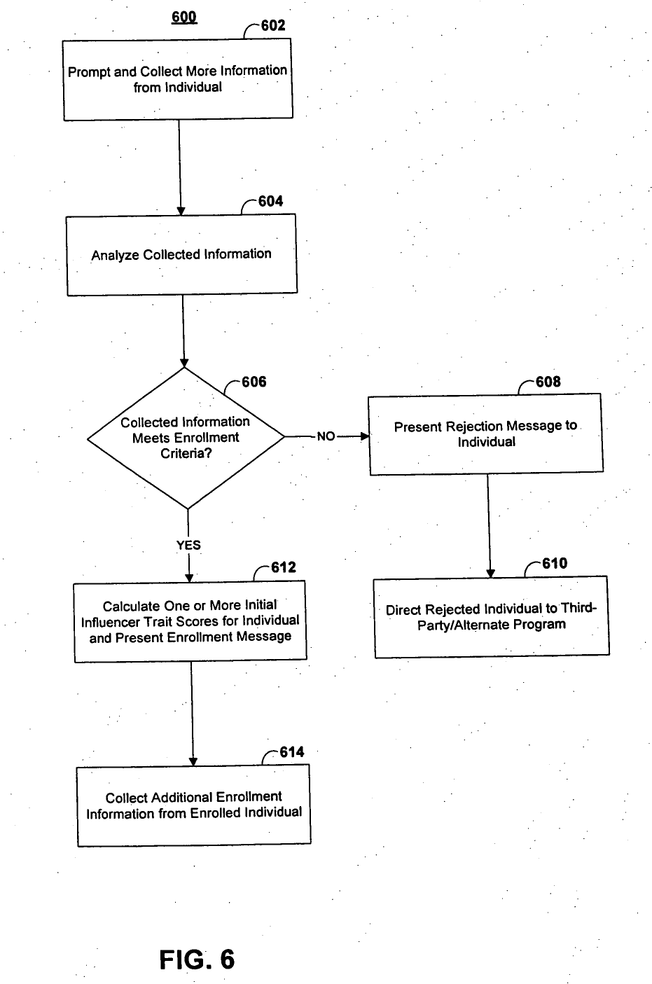

Acquire server 102 may use the results of screening component 106 in order to determine which social group members (i.e., potential influencer) should be enrolled as influencers and which social group members should not be enrolled. In some embodiments, all social group members may be enrolled as influencers regardless of the results of their interaction with screening component 106. FIGS. 5 and 6, below, describe illustrative processes for enrolling new influencers in more detail. Although screening component 106 is shown external to acquire server 102, screening component 106 may include one or more web services, application processes, or software routines running at least partially on acquire server 102 or on another device or system in network 100.

In some embodiments, screening component 106 (or any other of the applications or application processes described herein) may run using a client-server or distributed architecture where some of the application or application process is implemented locally on a client machine in the form of a client process and some of the application or application process is implemented at a remote location in the form of a server process. The application or application process may also be distributed between multiple devices, machines, or systems, if desired. There may be one machine per process, multiple machines per process, or multiple processes per machine.

For example, in actual implementations, screening component 106 may be partially implemented on acquire server 102 in the form of a server process and partially implemented on POS device 114, kiosk 116, and/or Internet website 118 in the form of a client process. User interactions with screening component 106 may be delivered to, or processed by, acquire server 102. For example, in some embodiments, screening component 106 takes the form of one or more interactive surveys hosted as a series of webpages. A user may interact with the webpages to cause a client network socket to transmit user responses to screening component 106 and then to acquire server 102. A corresponding server socket on screening component 106 and/or acquire server 102 may then receive the data from the client socket. Each of POS device 114, kiosk 116, and Internet website 118 may run one or more client application processes.

Screening component 106 may include one or more user surveys or any other data collection device. Each user survey or collection device may include a series of socio-demographic questions (e.g., age, income, family size, location), questions relating to consumer interests and spending habits, as well as questions relating to influencer traits. Questions relating to influencer traits may include, for example, questions used to compute or derive one or more initial influencer trait scores for the user participating in the screening component. For example, questions relating to influencer traits may include questions such as: “When you last discovered a product, idea, or service that you loved, how many people did you tell about it?”; “What have people usually done with your recommendations in the past?”; “About how many people do you talk to on a daily basis?”; and “How many clubs or organizations are you involved in?” Of course, the aforementioned questions are merely illustrative and any suitable number and type of questions may be included in screening component 106. The questions may help determine the participant's ability to influence other social group members as well as the number and quality of the participant's social group ties.

Screening component 106 may access stored questions, response choices, a predefined list of information terms, and any other screening data from a screening database, which may be co-located with screening component 106 or stored at a remote location. Screening component 106 may also store user responses, user contact information, and other personal information in the screening database. In some embodiments, the screening database may be located at acquire server 102, a suitable storage device in network 100, or a third-party location.

Although POS device 114, kiosk 116, and Internet website 118 may represent the most common types of devices used to interface with screening component 106, these devices are presented for illustration only. Individuals may also be recruited and screened via other communications devices, such as traditional or cellular telephones, PDAs (e.g., Blackberry devices), and the like. For example, an individual may press buttons on a telephone device to interact with screening component 106. If a telephone device is used to recruit or screen individuals, survey questions may be automatically converted or recorded as digital audio (e.g., as WAV, MIDI, or MP3 files) and stored in the screening database.

Network 100 also includes event server 104. Event server 104 may be primarily responsible for monitoring online and offline user interactions 112. Event server 104 may store campaign events in an event database, which may be co-located with event server 104, located at actual/artificial campaign component 108, at any other suitable device in network 100, or at a third-party location. In a typical usage scenario, after a user is enrolled via screening component 106, one or more campaign event notifications may be delivered to the enrolled user. The campaign event notifications may take many forms, including electronic messages (e.g., email, IM, or text messages) or more traditional forms of communication (e.g., telephone calls, voice mail messages, or postal mailings) soliciting participation in the actual or artificial campaign event. The campaign event notification may include a brief description of the campaign and instructions on how to participate in the event. For example, the campaign event notification may include a description of a new movie and a link to a website where the user may complete an online survey relating to the new movie. Examples of other campaign events are described in more detail below. Event server 104 coordinates campaign events as well as user interaction with events. Online and offline user interactions 112 may include any user interaction or activity performed in response to the campaign event notification. For example, online and offline user interactions 112 may include opening an email, visiting a website, completing an online survey, calling a particular telephone number, sending an email or other electronic message, forwarding the event notification to at least one friend or social group member (or a predetermined number of friends or social group members), or any other suitable activity.

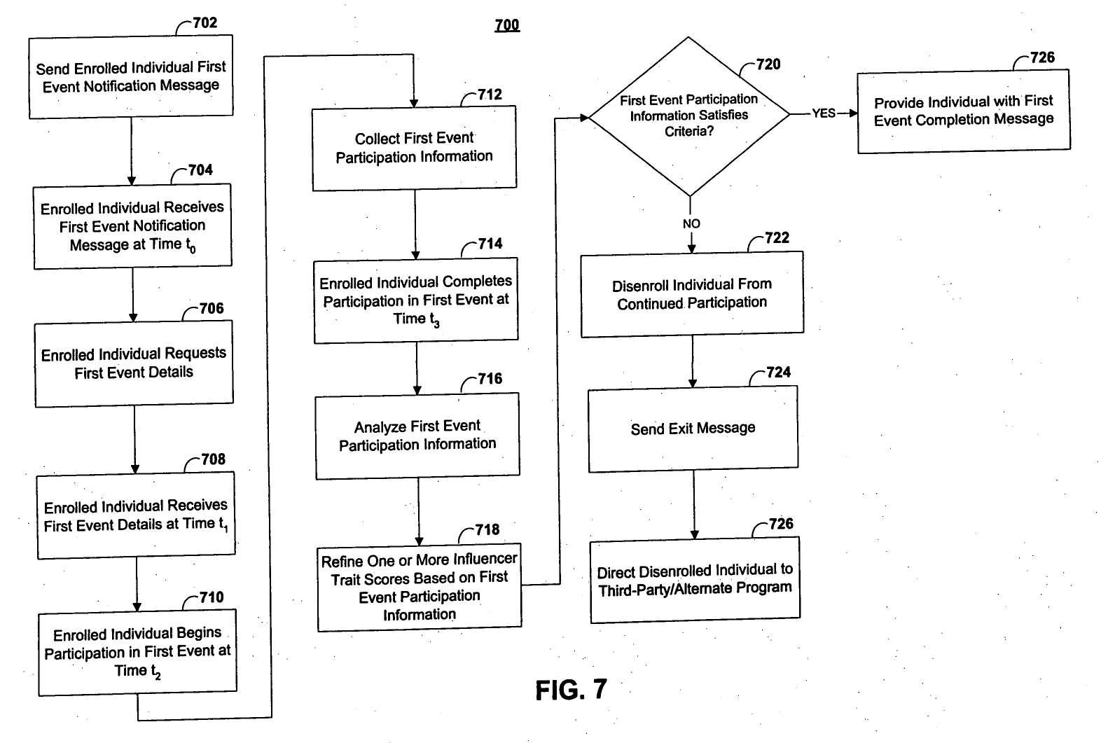

As described above, campaign events may be related to actual marketing campaigns or artificial, mock marketing campaigns. Information relating to the campaign may be stored in a campaign database, which may be co-located with campaign component 108, stored at event server 104, or at any other suitable location in network 100. Information in the campaign database may include, for example, survey questions, response choices, graphics, video, product and/or service descriptions, pricing information, availability information, advertising, or any other suitable campaign information. Event server 104 may access campaign information and deliver campaign event notifications to enrolled influencers, as described in more detail below in regard to FIGS. 7-9 below.

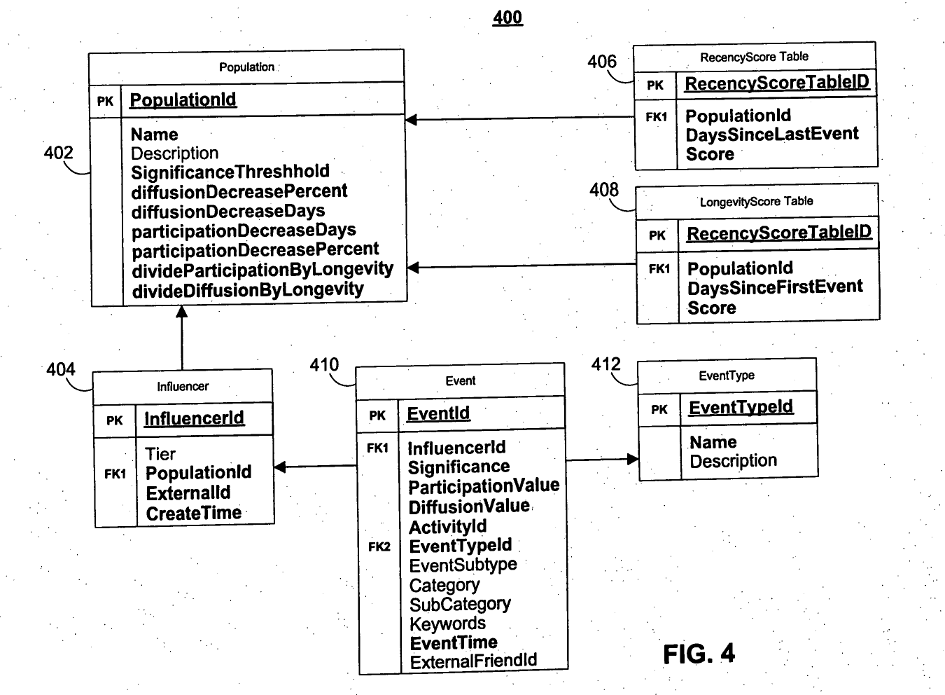

Event server 104 may also be in communication with scoring engine 110. Scoring engine 110 may calculate influencer trait scores for enrolled influencers. As described in more detail in FIGS. 3 and 4, scoring engine 110 may access a scoring database to read, update, or refine one or more influencer trait scores or other influencer information. The scoring database may be co-located with scoring engine 110, located at event server 104, or any suitable storage device in network 100. In some embodiments, scoring engine 110 is an application, application process, or subroutine running on event server 104. Each enrolled influencer may be associated with a number of influencer trait scores, or a group of enrolled influencers may share the same scores. In some embodiments, influencer trait scores for one or more of the influencer traits of participation, recency, diffusion, and longevity (or any other suitable trait) are calculated for each enrolled influencer, as described in more detail below.

The ability of an influencer to influence others within their social group is measured by the individual's influencer traits (and, as a result, influencer trait scores). Influencer traits typically result from a combination of an individual's personality traits and behavioral characteristics that contribute to one's personal motivation and ability to interact with other individuals in at least a portion of a social group. An individual possessing influencer traits, or a suitable degree of influencer traits, has the ability to generate interest in (i.e., “buzz” or positive WOM) and/or influence the purchase of goods and services within all or a portion of the individual's social group.

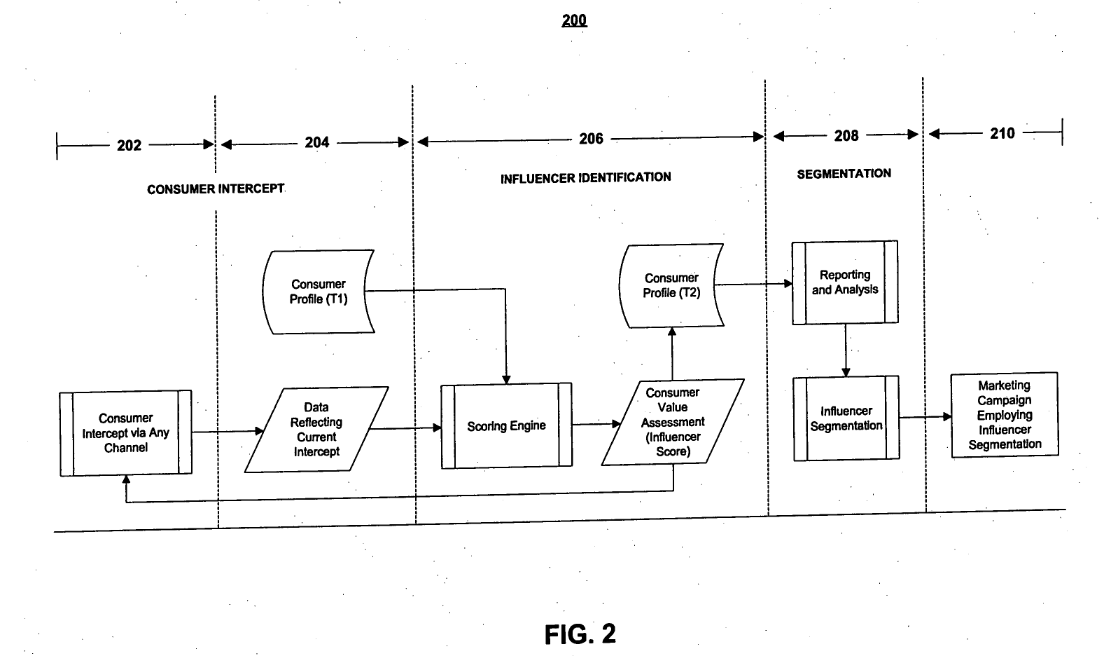

FIG. 2 shows illustrative timeline 200 for engaging, identifying, segmenting, and then reengaging individual consumers in support of a marketing program. A consumer may include any individual who is exposed to a company, a marketing program, or a consortium of companies and/or marketing programs. In accordance with the present invention, consumers' observed (i.e., actual) and stated behavior is monitored and/or assessed and made available to the scoring engine for analysis.

As described above, consumers may be intercepted through a variety of different channels, including, but not limited to, the Internet (e.g., email, HTTP/web based technologies, client-server applications, peer-to-peer applications, and instant messaging applications), telephony devices or services (call centers, IVR systems, and mobile/wireless devices), direct-mail (business reply cards, surveys, and other direct response materials), interactive television or interactive kiosks, and human or computer-aided interviews. Consumers are intercepted via one or more of the aforementioned channels at time 202.

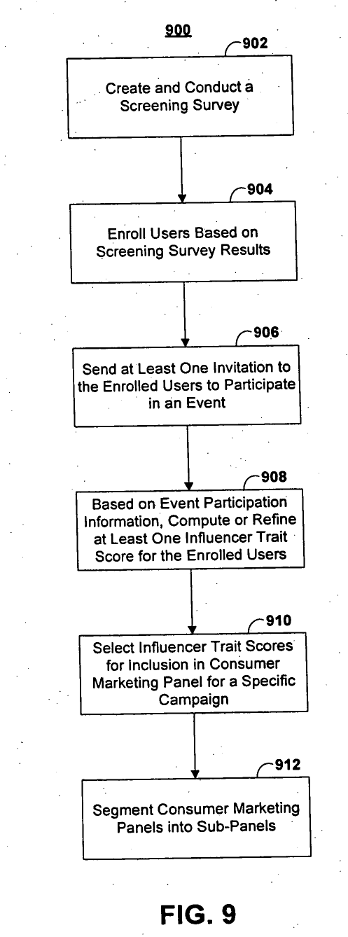

Data is collected about the consumers over one or more of these channels and analyzed at time 204, which may be some time after time 202. For example, screening component 106 (FIG. 1) may be used to collect consumer information over a wide variety of channels. This data is then made available to the scoring engine (e.g., scoring engine 110 of FIG. 1) at time 206, which may be some time after time 204. During time 204, a consumer profile (T1) may also be generated (or accessed if already stored) for each consumer. The consumer profile may include previously-captured data and such information as the population that consumer belongs to, the geographic region the consumer lives or shops in, socio-demographic information about the consumer, contact information, or any other suitable information. The data collected via the various channels may be made available either alone or in conjunction with the previously-captured data from the consumer profile (T1) to the scoring engine at time 206, which may be some time after time 204. The scoring engine may include scoring engine 110 (FIG. 1). The scoring engine uses this data to compute or refine a consumer value assessment, or influencer “score” for the consumer. This influencer score may be indicative of the consumer's ability to influence other individuals in the consumer's social group. The score is immediately made available for marketing purposes and can be captured to a new or updated consumer profile (T2) for later use. For example, at time 208, which may be some time after time 206, consumer profile (T2) may be created using consumer profile T1 data and any newly-colleted data. The data in the consumer profile (T2) may be organized and then reported to marketers. Alternatively or additionally, at time 208 consumers may be segmented into one or more groups or sub-groups based on any suitable segmentation criteria, as described in more detail below in regard to FIG. 9. Finally, at time 210, which may be some time after time 208, the segmented influencers may be used in future marketing campaigns.

It is important to note that one or more of the steps in illustrative timeline 200 may be repeated one or more times. For example, in some embodiments, consumer data is collected through various channels continuously, or at least periodically. In this way, the scoring engine may always have current, up-to-date information for which to compute accurate consumer value assessments (i.e., influencer scores).

FIG. 3 shows illustrative process 300 for scoring influential consumers (i.e., potential influencers). The scoring engine accepts data representing any observable or claimed consumer behavior (i.e., an “event”), past and present, and provides a consumer value assessment or influencer “score” by interpreting this data. Events are observed or input into the system at step 302. For example, a consumer may participate in one or more online surveys, visit a website, read an email, call an IVR system or call center, mail in a direct mailing, or interact with an in-store kiosk. Data from the event reflecting the current consumer intercept is derived from the event at step 304. For example, consumer responses to an online survey may be read and stored in a database, such as the screening database of screening component 106 (FIG. 1). Event server 104 (FIG. 1) may monitor all consumer even activity. In some embodiments, data from the event is manually input to event server 104 (FIG. 1) at step 304. This data may be combined with consumer profile data at step 306 and passed through one or more of standard event models 308 and custom event models 310. The data is interpreted according to these event models, which allows the data to be evaluated according to metrics that best represent the value being measured. Standard event models 308 may be used for evaluating consumer behaviors according to standard metrics indicative of social networking value. Custom event models 310 may include refined standard event models that are tailored to a specific population (e.g., teens or moms), a particular group of consumers (e.g., teenagers residing in New York City), a particular business category (e.g., health and beauty products and/or services), or a particular marketer.

The metrics defined by standard event models 308 and custom event models 310 are components of a holistic score, including individual metrics of diffusion 312, participation 314, recency 316, and longevity 318. Although these four metrics are preferably used in some embodiments, one or more of these metrics may be removed (or given any suitable weight, as described in more detail in regard to FIG. 4). In addition, other suitable social networking metrics may be defined at other dimensions 320.

Component scores corresponding to each of the individual metrics of diffusion 312, participation 314, recency 316, and longevity 318 (and any other optional metrics from other dimensions 320) may be generated according to a set of standard scoring rules 322 and custom scoring rules 324. Standard scoring rules 322 are described in more detail in regard to FIG. 4, below, and may be used to evaluate consumers according to a standard scale of social networking value. These standard rules may be refined for individual populations, business sectors, or marketers, and custom rules 324 may be developed. For example, weights may be assigned to certain consumer events, resulting in more or less of an impact on selected component scores, as described in more detail below.

Using standard scoring rules 322 and custom scoring rules 324, scoring engine 326 (which may include scoring engine 110 of FIG. 1) may compute a value assessment or score for each consumer. This value assessment may be stored for later use in consumer profile 330 and may be immediately available for marketing purposes. The value assessment is also used to produce segmentation models 332 to support continuing analysis of consumers and for comparison to standard population models 336 at reporting and analysis step 334. This analysis may then be used to refine both custom event models 310 and custom scoring rules 324, thus improving scoring accuracy.

FIG. 4 shows illustrative scoring tables 400 in one embodiment of the invention. Scoring tables 400 may include one or more of population table 402, influencer table 404, recency score table 406, longevity score table 408, event table 410, and event type table 412. All of the aforementioned tables may be stored in a scoring database at scoring engine 110 (FIG. 1) or any other suitable location remote from scoring engine 110 (FIG. 1). In the example of FIG. 4, the primary database key for each table is listed by “PK” and the foreign key or keys for each table are listed by “FK.” Fields in bold may be required fields while fields in regular typeface may be optional fields. More or less tables than those shown in the example of FIG. 4 may be defined with more or less fields (and with different primary and foreign keys) in other embodiments.

Population table 402 includes information about a set of influencers who are to be scored together. For example, “moms” or “teens” may be suitable populations in one embodiment. Each population may be associated with a population identifier, name, and description. Population table 402 may also include scoring weights (e.g., 0 to 1, or a specified percentage value) for various influencer traits, such as diffusion and participation. By including influencer trait scoring weights in population table 402, weights may be applied to all influencers associated with a given population. For example, the “moms” population may have different scoring weights than the “teens” population. Since, in some embodiments, individual influencers may belong to more than one population, an influencer may be associated with multiple scores for the same influencer trait, depending on what population the influencer is being scored for. In one embodiment, the scoring weights may indicate a percentage to decrease a diffusion and/or participation influencer trait score along with a number of days in the past an event must have occurred in order to decrease that score by the specified percentage. Weights for other influencer trait scores may also be defined.

Population table 402 may also include a significance threshold. This value may be used to distinguish important events from trivial or less important events. As discussed below, events may be associated with a significance value (e.g., an integer from 0 to 9). The significance threshold may determine whether the event is important enough to affect the influencer's recency influencer trait score (or any other influencer trait score). By customizing the significance threshold in population table 402, different populations may have different significance thresholds. The value for the significance threshold may be selected by the marketer and dynamically changed as needed.

Influencer table 404 includes information about enrolled influencers. Each enrolled influencer may have a row entry in influencer table 404. Influencers may also be associated with a tier level (e.g., tier 1, tier 2, or tier 3). The tier level may be assigned to the influencer based on the results of screening component 106 (FIG. 1) and any other suitable information known or observed about the influencer. For example, tier 1 influencers may have higher capabilities (as a measure of the influencer's initial influencer trait score or scores) than tier 2 influencers, and so on. Influencers may also be associated with one or more populations, a unique influencer identifier, an external identifier for use by external systems interfacing with scoring engine 110 (FIG. 1), and the time when the influencer was added to the population.

In some embodiments, influencer table 404 also contains personal information about each influencer (e.g., name, address, age, telephone number). In other embodiments, all personal information is stored separately from influencer table 404 to ensure the privacy of the influencers. The personal information may also be stored at a secure marketing site, inaccessible by scoring engine 110 (FIG. 1). In such embodiments, the scoring engine may reference and report influencer trait scores for each influencer by the influencer's unique identifier only.

Event table 410 may include information relating to every activity or interaction in which an influencer (or a friend or social group member of an influencer) has participated. Event table 410 may include a unique event identifier for each event, an event type (such as the event types described in event type table 412), the influencer identifier associated with the event, the significance of the event, a participation influencer trait increment score, a diffusion influencer trait increment score, and the time and/or date the event occurred or was completed. The increment scores associated with an event may be used to calculate raw influencer trait scores. Some influencer trait scores may simply be the sum of all the increment score values associated with events the influencer has generated (i.e., participated in). For example, the participation and diffusion influencer trait scores for an influencer may be computed in accordance with:

$$score = {\sum }_{i = 1}^{N} {w}_{i} {v}_{i} \qquad ( EQ 1 )$$

where N is the total number of events associated with the influencer in event table 410, wᵢ is some weight (e.g., between 0 and 1) assigned to the event, and vᵢ is the participation or diffusion increment value associated with the event. As shown in event table 410, fields “ParticipationValue” and “DiffusionValue” may hold the increment values for the influencer's participation influencer trait score and the diffusion influencer trait score, respectively. The value used for the weight for each event may be derived from the significance associated with the event (e.g., as stored in the “Significance” field in event table 410) or may depend on the age of the event.

For example, in some embodiments, participation and/or diffusion influencer trait scores are adjusted based on when the event was generated. This adjustment may produce a score that more accurately reflects the reality of the influencer's ability to influencer other social group members. For example, population table 402 may define a number of days in the past an event must have occurred before the event's participation and/or diffusion increment value is reduced. In the example of population table 402, these values are stored in the “diffusionDecreaseDays” and “participationDecreaseDays” fields. If an event occurred more than the number of days specified in either of these two fields, then the corresponding influencer trait increment score associated with the event may be reduced by the percentage specified in population table 402. In some embodiments, scores may be reduced by a multiple or fraction of the specified percentage. For example, if the event occurred more than twice the number of days specified in the “diffusionDecreaseDays” or “participationDecreaseDays” fields, the score may be reduced twice the by specified percentage. The scoring engine may compute the reduced score in accordance with:

$$newScore = score - ( score * ( decreasePercent * ( \frac{currentDate - eventDate}{decreseDays} ) ) \qquad ( EQ 2 )$$

where currentDate is the date the score computation takes place and eventDate is the date of the event. Other suitable algorithms to adjust influencer trait scores based on the age of the score may be used in other embodiments.

Longevity score table 408 may be used to compute longevity influencer trait scores for enrolled influencers. Longevity score table 408 may include one or more population identifiers to associate the information in longevity score table 408 with, a field for the number of days since the first event recorded for the influencer, and a field for the score associated with an influencer with the corresponding longevity. For example, longevity score table 408 may include the information in Table 1, below. Scoring engine 110 (FIG. 1) may look up an influencer's longevity score directly from Table 1 in some embodiments. The values in Table 1 are merely illustrative. Any suitable values may be used based on the granularity of score desired.

TABLE 1
Illustrative longevity influencer trait scores for corresponding days
since an influencer's first event.

| DaysSinceFirstEvent | Score |
|---|---|
| 1 | 0 |
| 2 | 1 |
| 7 | 2 |
| 14 | 3 |
| 21 | 4 |
| 28 | 5 |
| 60 | 6 |
| 90 | 7 |
| 180 | 8 |
| 365 | 9 |

Recency score table 406 may be used to calculate an influencer's recency influencer trait score. Similar to longevity score table 408, recency score table 406 may be associated with one or more influencer populations. The table may also include a field for the number of days since the last event recorded for the influencer and a field for the score associated with an influencer with the corresponding recency. For example, recency score table 406 may include the information in Table 2, below. Scoring engine 110 (FIG. 1) may look up an influencer's recency score directly from Table 2 in some embodiments. The values in Table 2 are merely illustrative. Any suitable values may be used based on the granularity of score desired.

TABLE 2
Illustrative recency influencer trait scores for corresponding days
since an influencer's last recorded event.

| DaysSinceLastEvent | Score |
|---|---|
| 366 | 0 |
| 365 | 1 |
| 180 | 2 |
| 120 | 3 |
| 90 | 4 |
| 60 | 5 |
| 30 | 6 |
| 14 | 7 |
| 7 | 8 |
| 2 | 9 |

Finally, event type table 412 may be used to define the types of events recorded in event table 410. Event type table 412 may include a unique event type identifier, a name for the event type, and a description for the event type. As previously described, events may include any user interaction or activity in response to campaign event notifications. Events may also include system-created or automated events, such as the creation of an influencer and the delivery of an actual or artificial campaign notification to an influencer. Events may also include user offline and online interactions, such as an influencer or an influencer's friend (or social group member) starting a survey, an influencer or an influencer's friend completing a survey, an influencer or an influencer's friend accessing or viewing a webpage, an influencer or an influencer's friend accessing or viewing an email, an influencer or an influencer's friend purchasing a product or service, or any other suitable event that a marketer wishes to monitor and include in the influencer trait scoring process.

FIG. 5 shows illustrative process 500 for recruiting potential influencers in one embodiment of the invention. At step 502, an individual initiates an online or offline consumer activity relating to a product or service. For example, the individual may mail in a product registration card, call an interactive voice response (IVR) system of a marketer, manufacturer, or service provider, initiate an online information search, or any other suitable consumer activity. At step 504, a determination is made whether the individual's activity meets a predefined criteria. For example, as described above, a list of predefined information search terms may be stored in a database. If an individual's information request matches a term in the predefined list, the criteria may be satisfied. As another example, if a consumer sends in a product registration card or calls an IVR system requesting information about a particular product or service, the predefined criteria may be satisfied.

In one embodiment, the information request provided by the individual is in the form of a written request for information in the form of a customer information request card that is provided with a printed product advertisement. Upon receipt of the information request, a comparison of the information request is made with a set of information terms. If it is determined through the comparison that the information request is sufficiently related to the information terms, the predefined criteria may be satisfied

If, at step 504, the predefined criteria is satisfied, an invitation may be presented to the individual at step 506. If the predefined criteria is not satisfied, illustrative process 500 may return to step 502 to await another online or offline consumer activity. The term “invitation” may include any solicitation presented to an individual in order to encourage or enable participation in a marketing campaign, event, or screening process. The invitation may include advertising, text, static graphics or illustrations, dynamic graphics or illustrations, video, application, and combinations thereof The invitation may also include additional information related to the product or service associated with the initial consumer activity at step 502 or instructions for viewing, listening to, downloading, linking to, or otherwise obtaining the additional information. The invitation may enable participation by providing a link for automatically accessing screening component 106 (FIG. 1).

In some embodiments, the invitation contains a link or address of a “landing page.” The landing page may include information about participating in one or more marketing activities or campaign events as an influencer. The landing page may also include additional information relating to influential marketing programs that may be of interest to the individual. The influential marketing program information may be of a generic nature, or may be customized based on information known specifically about the individual (e.g., personally identifiable information), about one or more demographic characteristics of the individual (e.g., age, sex, race/ethnicity, location of residence, nationality, occupation/profession, education, family size, marital status, ownerships (e.g., home, car, pet, and the like), language, mobility, and life cycles (fertility, mortality, migration, and the like)), about one or more personal characteristics of the individual (e.g., hobbies, activities, interests, experiences, and the like), and combinations thereof.

The invitation and the landing page or pages may exist in a variety of formats, including electronic, printed, auditory, visual, or combinations thereof. In one embodiment, the invitation and/or landing page includes a printed, hard-copy document, or set of documents, delivered to or otherwise made available to the individual. In another embodiment, the invitation and/or landing page is incorporated into an electronic document, such as electronic mail or a window, frame, page, or application on the Internet that is delivered or otherwise made available to the individual. In yet another embodiment, the invitation and/or landing page is incorporated as part of a computer readable medium device (such as a CD, DVD, or USB flash drive) delivered to the individual. In addition to the invitation or landing page itself, the computer readable medium may also comprise additional elements intended to entice or otherwise encourage the individual to accept the invitation or access the landing page. These additional elements may include free or discounted product or service offerings, coupons, sweepstakes entries, or any other incentive.

At step 508, a determination is made whether the individual has accepted the invitation. For example, the user may select or click a link embedded in the invitation to accept the invitation. The individual may also mail in a return postcard to accept the invitation, visit the landing page (e.g., an Internet website), or run or install an application locally. If the individual accepts the invitation at step 508, the individual may be initially screened for influencer traits at step 510. For example, the individual may be directed to screening component 106 (FIG. 1). If the individual does not accept the invitation at step 508, illustrative process 500 may return to step 502.

In practice, one or more steps shown in process 500 may be repeated, combined with other steps, performed in any suitable order, performed in parallel—e.g., simultaneously or substantially simultaneously—or removed.

FIG. 6 shows illustrative process 600 for screening potential influencers in one embodiment of the invention. At step 602, more information is collected about a potential influencer. For example, a traditional or Internet-based survey or questionnaire including a plurality of questions may be presented to the potential influencer. The survey or questionnaire may be designed to collect additional information from the potential influencer related to one or more influencer traits. The survey or questionnaire may also collect other information, such as socio-demographic information, interests and hobbies information, consumer habits, and the like. The survey or questionnaire may be a multi-component information collection device, existing in several parts or components, with specific information being collected by each component. In one embodiment, the collection device is a multi-part survey that is presented over a computer network via a series of linked webpages. Each component of the survey may correspond to a different webpage, with each component collecting a specific of information.

The information collected may be analyzed at step 604. For example, screening component 106 or acquire server 102 (both of FIG. 1) may collect, store, and/or sort the information into one or more tables of a relational database. At step 606, a determination is made whether the collected information meets a minimum enrollment criteria. For example, some questions in the information collection device, survey, or questionnaire may be designated as enrollment questions having valid enrollment response choices. If the potential influencer does not respond with one or more valid enrollment response choices, a determination may be made at step 606 that the potential influencer does not meet the enrollment criteria. In other words, in order for a potential influencer to meet the enrollment criteria, the potential influencer may be required to respond a particular way on one or more questions in the survey, questionnaire, or collection device. The enrollment criteria question or questions may relate to one or more influencer traits, the legal requirements for participation (e.g., age), interests and hobbies, social connections, or any other criteria that is related to influential marketing to social groups. In other embodiments, all potential influencers are initially enrolled regardless of the results of step 606.

If a potential influencer fails to meet the enrollment criteria, a rejection message may be presented to the rejected influencer at step 608, and the rejected influencer may be enrolled in an alternate program or directed to third-party information at step 610. For example, the rejected influencer may be directed to a sponsor's, marketer's, or advertiser's website. Additionally or alternatively, the rejected influencer may be directed to a website of, or receive communication from, a third party that relates to the interests of, or the information provided by, the rejected influencer.

If, on the other hand, the potential influencer meets the enrollment criteria, the influencer may be added to the scoring database and at least one initial influencer trait score may be calculated for the enrolled influencer at step 612. In one embodiment, scoring engine 110 (FIG. 1) calculates an influencer trait score for the enrolled influencer for one or more of the influencer traits of longevity, participation, diffusion, and recency. The initial values of these scores may be based, at least in part, on the information collected at step 602 and analyzed at step 604 or step 606. After an influencer is enrolled, additional information may be collected from the influencer at step 614. This information may include contact information, if not previously collected, so that campaign event notifications may be delivered to the enrolled influencer at a later time.

In some embodiments of the invention, immediately after an influencer is enrolled, the influencer may be invited to participate in one or more campaign events to help validate, or refine, one or more of the influencer's initial influencer trait scores. As described above, since information provided by a consumer is typically not very reliable, validation or refinement of influencer trait scores is crucial to reliable, accurate results. Scores may be validated or refined periodically, continuously, or on any other suitable schedule.

In practice, one or more steps shown in process 600 may be repeated, combined with other steps, performed in any suitable order, performed in parallel—e.g., simultaneously or substantially simultaneously—or removed. For example, in some embodiments, step 606 is removed and all potential influencers who are interested in joining are enrolled regardless of whether the collected information meets the enrollment criteria.

FIG. 7 shows illustrative process 700 for validating one or more influencer trait scores associated with an enrolled influencer. At step 702, the enrolled influencer is sent a first event notification message. The first event notification message may be an electronic message (e.g., email message, text message, IM), telephone call (i.e., voice message), or paper message. The message may invite the enrolled influencer to participate in an artificial or actual marketing campaign event. The message may also inform the enrolled influencer that he or she has been selected to participate in a marketing program and that additional information and/or instructions related to the first marketing program may be obtained by visiting the enrolled member page. The enrolled influencer page may include a personalized and/or customized portion of a private computer network or website dedicated to information related to the enrolled influencer and the programs in which the enrolled influencer is currently and has previously participated.

The first marketing program is designed to directly and indirectly collect information from the enrolled influencer related to one or more influencer traits of the enrolled influencer. The first marketing program is also designed to directly and indirectly collect information from the enrolled influencer to validate the self-reported information related to one or more influencer traits of the enrolled influencer collected during the enrollment process. As described above, the artificial or actual marketing program may request that the enrolled influencer take some action, such as visit a website, complete a survey, or any other suitable activity.

At step 704, the enrolled influencer received the first event notification at time to. At step 706, the enrolled influencer may then request additional information or details about the first event. At step 708, the enrolled influencer may receive first event details at time t₁. For example, event server 104 (FIG. 1) may access a campaign database of campaign component 108 (FIG. 1) and send event details to the enrolled influencer. The enrolled influencer may begin participation in the first event at time t₂. For example, the enrolled influencer may visit a website and begin taking a campaign survey. During participation in the event, participation information, such as survey responses, may be collected at step 712. At step 714, the enrolled influencer may complete the first event at time t₃. The information collected at step 712 is then analyzed at step 716. For example, the information may be automatically or manually analyzed by scoring engine 110 (FIG. 1) or event server 104 (FIG. 1). One of these components may then adjust or refine one or more influencer trait scores associated with the enrolled influencer based on the first event participation information at step 718. For example, completing a significant event may affect one or more of the enrolled influencer's participation, longevity, recency, or diffusion influencer trait scores. The time between components of the marketing program may also be monitored. For example, any of the aforementioned time values (or time intervals between any of the aforementioned time values) may be used to adjust influencer trait scores in some embodiments.

If it is determined, at step 720, that some portion of the information provided by the enrolled influencer does not satisfy a predetermined criteria, then the enrolled influencer may be disenrolled at step 722. For example, one or more of the influencer trait scores may have fallen below a predefined threshold level or the enrolled influencer may have otherwise not responded to a survey question with a valid response required for continued participation. To disenroll the influencer at step 722, one or more entries may be removed from scoring tables 400 (FIG. 4). The disenrolled influencer may then be provided an exit message at step 724. In one embodiment, the exit message is contained on an exit page, which is a portion of a computer network, such as a webpage, to which the disenrolled member is directed. The exit page may also contain additional information related to the enrolled member and his or her participation in the first marketing program. In another embodiment, the exit message is contained in a postal mail or email communication that is sent to the influencer. The exit message may also be delivered by some other form of communication media such facsimile, telephone, and the like. Additionally or alternatively, at step 726, the influencer may, at a time proximate to receiving the exit message or in lieu of the exit message, be enrolled in an alternate program, directed to a website of, or receive communications from, a third party that relates to the interests of, or the information provided by, the influencer. In some embodiments, after being provided an exit message, the influencer is directed to the website of a third party where the influencer may receive coupons or vouchers for free or discounted goods and services (or other incentives) as a gratuity for participation in the marketing program.

If, at step 720, the requirements for continued participation is met, then the enrolled influencer may be provided a message indicating successful completion of the first marketing program at step 728. In one embodiment, the successful completion message is contained on a successful completion page, which is a portion of a computer network such as a webpage, to which the enrolled influencer is directed. The successful completion page may also containing additional information related to the enrolled influencer and his or her participation in the first marketing program. In another embodiment, the successful completion message is contained in a postal mail or email communication that is sent to the enrolled influencer. The successful completion message may also be delivered by some other form of communication media such as facsimile, telephone, and the like. Additionally or alternatively, the enrolled influencer may, at a time proximate to receiving the successful completion message, be directed to a website of, or receive communications from, a third party that relates to the first marketing program, or the interests of, or the information provided by, the enrolled influencer. In some embodiments, after successful completion of the first marketing program, the influencer is directed to the website of a third party where the enrolled member may receive coupons for free or discounted goods and services (or other incentives) as a reward for successful completion of the marketing program.

In practice, one or more steps shown in process 700 may be repeated, combined with other steps, performed in any suitable order, performed in parallel—e.g., simultaneously or substantially simultaneously—or removed.

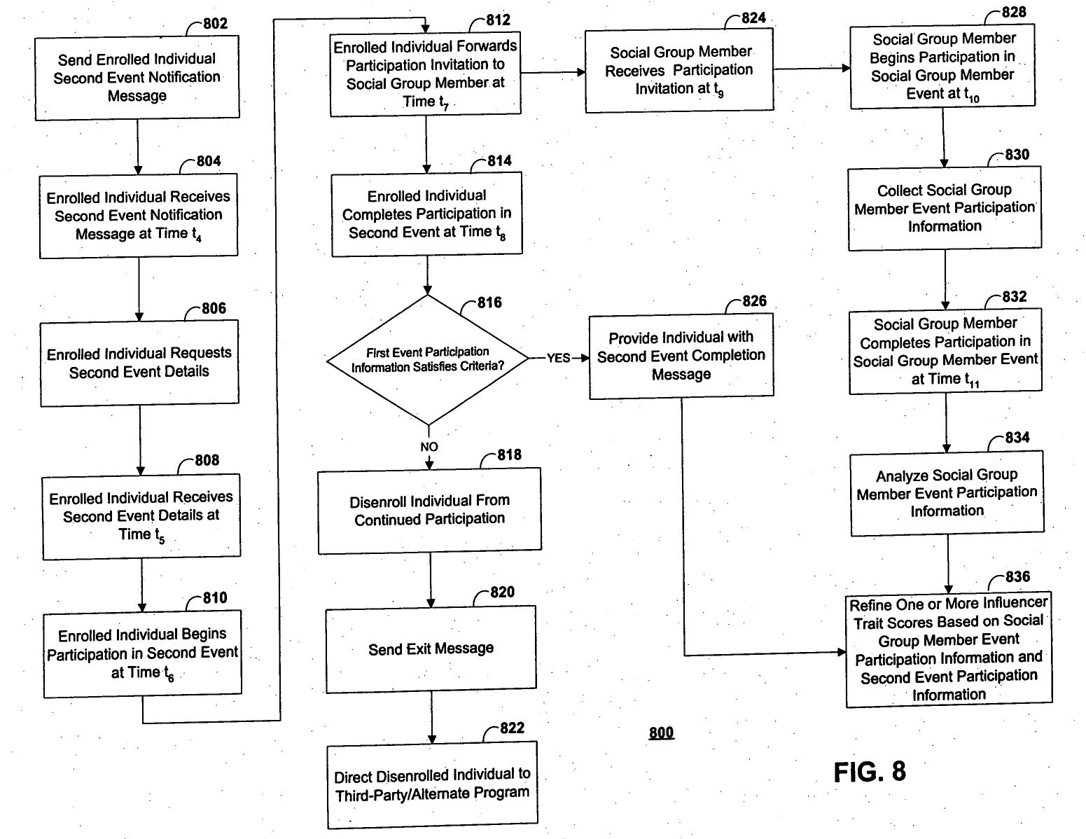

FIG. 8 shows illustrative process 800 for validating an influencer's diffusion influencer trait score. As with the first validation process shown in FIG. 7, this second validation process may include an artificial or actual marketing program. This process, however, involves the interaction of not only the enrolled influencer, but also the interaction of a friend or social group member of the enrolled influencer. Accordingly, illustrative process 800 is useful for refining or validating the diffusion influencer trait score.

An enrolled influencer's participation in a second marketing program may begin at step 802 with a second event notification message being sent to the influencer. At step 804, the enrolled inflamer may receive the event notification message at time t₄. The communication may contain information and instructions related to the enrolled influencer's participation in the second marketing program. In one embodiment, enrolled influencers are sent an email communication at an email address provided by the enrolled member upon enrollment (or any time thereafter). The email communication may inform the enrolled member that they have been selected to participate in a marketing program and that additional information and/or instructions related to the second marketing program may be obtained by visiting the enrolled member page. The enrolled influencer may request event details at step 806 and be provided with the event details at time t₅ at step 808.

At step 810, the enrolled influencer may begin participating in the campaign event at time t₆. For example, the influencer may start a survey at time t₆. At step 812, the influencer may forward the participation information to a social group member at time t₇. For example, the influencer may be asked to forward the email event notification message to one or more friends, co-workers, or any other social group members. At this point, the participation of the social group member or members and the influencer may both be monitored by event server 104 (FIG. 1). The social group member may then be sent an event notification message and requested to participate in a social group member event. The social group member may begin participation the social group member event at step 828 at time t₁₀. The social group member event may relate to the same or different campaign as the second campaign event. Information may be collected from the social group member at step 830, and the social group member may complete the social group member event at step 832 at time t₁₁. Information from the social group member event may then be analyzed at step 834. For example, information about the event may be added to event table 410 (FIG. 4). The social group member may also be analyzed for enrollment as an influencer in some embodiments.

After the influencer forwards the participation invitation to a social group member at step 812, the enrolled influencer may complete the second campaign event at step 814 at time t₈. A determination is then made at step 816 whether the enrolled influencer has satisfied the predetermined criteria to continue participation. If it is determined, at step 816, that some portion of the information provided by the enrolled influencer does not satisfy the predetermined criteria, then the influencer may be disenrolled at step 818 and provided an exit message at step 820. As described above with regard to FIG. 7, the disenrolled influencer may then be enrolled in an alternate program or directed to a third party at step 822.

If, at step 816, the requirements for continued participation in additional marketing programs are met, then the enrolled influencer may be provided a message indicating successful completion of the second marketing program at step 826. Using either or both participation information from the social group member event or the second campaign event, one or more of the influencer trait scores associated with the influencer may be refined at step 836. In some embodiments, the refinement is based, at least in part, on the time between components of the second marketing program. For example, any of the aforementioned time values (or time intervals between any of the aforementioned time values) may be used to adjust or refine influencer trait scores at step 836.

It will be understood that additional actual and/or artificial marketing programs or campaign events designed to validate self-reported or collected information about an enrolled influencer may be designed and executed, either concurrently or following the marketing programs described above. In one suitable approach, enrolled influencers are periodically (e.g., once a week) delivered event notification messages throughout the influencer's life of enrollment. Influencer trait scores may be automatically refined over time as more information is collected about the influencer and/or the influencer's social group members. In this way, influencers may be always associated with up-to-date and reliable influencer trait scores.

Influencer trait scores may be reported in a number of ways. For example, database queries of the scoring database may retrieve influencer trait scores. The database may include a number of views that show scores for a particular influencer or for a population. Composite scores RPD (recency, participation, and diffusion) and RPDL (recency, participation, diffusion, and longevity) may be defined as a 3-digit or 4-digit scores, with each digit of the composite score representing a different influencer trait score. For example, the RPDL composite score “9876” may represent an influencer with a recency score of 9, a participation score of 8, a diffusion score of 7, and a longevity score of 6. Composite scores may be created in this manner, or using any other suitable approach. In general, higher scores correspond to influencers with a greater ability to influence other social group members. These influencers may be more valuable in the WOM marketing context.

In practice, one or more steps shown in process 800 may be repeated, combined with other steps, performed in any suitable order, performed in parallel—e.g., simultaneously or substantially simultaneously—or removed.

FIG. 9 shows illustrative process 900 for creating a consumer marketing panel of influencers in one embodiment of the invention. At step 902, a screening survey may be created and conducted. For example, users may interact with screening component 106 (FIG. 1) at in-store kiosks, over the telephone, or via the Internet. Based on the screening survey, users are enrolled for participation in the consumer marketing panel at step 904. At least one invitation is then sent to the enrolled users at step 906. The invitation may solicit the users to participate in one or more actual or artificial marketing campaigns, as described above. In some embodiments, more than one type of invitation may be sent to select subsets of the available influencers in a population. The type of invitation sent may determine whether the influencer participates in the full campaign or an abridged (or otherwise modified) version of the campaign. In some embodiments, the type of invitation sent depends on the influencer's ability to drive WOM, as determined by one or more of the influencer's influencer trait scores or any other known, observed, or computed information about the influencer. For example, influencers designated as tier 1 influencers may be sent an invitation to participate in the full marketing campaign, which may include, for example, a postal mail component with a free sample of a product or a coupon for a free service. Tier 2 influencers may be sent an invitation to participate in an abridged (or otherwise modified) version of the campaign, which may include, for example, a postal mail component with a coupon for a product or service at a reduced price (as opposed to free). Tier 3 influencers may be sent, for example, an electronic (e.g., email) invitation to participate in the online version of the campaign only. In this way, return on investment may be maximized by investing more in highly-influential individuals and investing less in less-influential individuals. Based on participation information relating to the one or more marketing campaigns, at step 908 at least one influencer trait score is computed or refined. For example, an initial influence trait score may be computed based on the results of the screening survey, and the initial score may be refined using one or more subsequent marketing campaigns.

At step 910, a marketer may select a desired influencer trait score for inclusion in a consumer marketing panel for a specific campaign. In some embodiments, a minimum score is selected by the marketer, while in other embodiments a range of scores is selected at step 910. For example, an RPD composite influencer trait score of “888” may be selected by the marketer as the minimum influencer trait score to be included in the consumer marketing panel. As another example, an RPD composite influencer trait score range of “766” to “888” may be selected by the marketer to be included in the consumer marketing panel. Regardless of the score (or range of scores) selected, a database query may be performed at step 910 to identify the enrolled users meeting or exceeding the selected influencer trait score. The marketer may then segment the identified influencers into one or more sub-panels at step 912. The segmentation may be based on any suitable criteria, including age, race, income, product and/or service interests, spending habits, or any other socio-demographic criteria. The segmentation may also be based on one or more influencer trait scores or tier levels. The consumer marketing panel of influencers may then be used in social marketing, WOM, or viral marketing campaigns. As described in more detail in commonly-assigned U.S. patent application Ser. No. 11/508,031, filed Aug. 21, 2006, influencers may be used to refine a marketing message to maximize its WOM potential. Influencers may also be used to hasten adoption and/or awareness of a new product or service.

In practice, one or more steps shown in process 900 may be repeated, combined with other steps, performed in any suitable order, performed in parallel—e.g., simultaneously or substantially simultaneously—or removed.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for identifying influential members of social groups, the method comprising:
collecting consumer data from at least one consumer over at least one channel;
analyzing the collected consumer data for at least one social networking metric;
computing at least one social networking score for the at least one consumer based at least in part on the collected consumer data; and
refining the at least one social networking score, wherein refining the at least one social networking score comprises sending an invitation to participate in at least one marketing event to the at least one consumer.

2. The method of claim 1 further comprising monitoring the participation of the at least one consumer in the at least one marketing event.

3. The method of claim 2 wherein monitoring the participation of the at least one consumer in the at least one marketing event comprises computing the time between when the marketing event notification was sent to the at least one consumer and when the event notification was accessed.

4. The method of claim 2 wherein monitoring the participation of the at least one consumer in the at least one marketing event comprises computing the time between when the event notification was accessed and when the marketing event was started.

5. The method of claim 2 wherein monitoring the participation of the at least one consumer in the at least one marketing event comprises computing the time between when the marketing event was started and when the marketing event was finished.

6. The method of claim 1 wherein collecting consumer data from the at least one consumer over at least one channel comprises receiving consumer responses to at least one survey question.

7. The method of claim 6 wherein the at least one survey question comprises an online survey.

8. The method of claim 1 wherein analyzing the collected consumer data comprises determining if the at least one consumer fails to meet a predefined consumer threshold criteria.

9. The method of claim 8 wherein the predefined consumer threshold criteria is selected from the group consisting of a minimum age, a maximum age, a minimum income, a maximum income, a minimum family size, a maximum family size, a particular ethnicity, a particular sex, a particular geographic region of residence, and certain consumer habits.

10. The method of claim 1 wherein computing at least one score for the at least one consumer comprises computing at least one score for each of the social networking metrics of diffusion, participation, longevity, and recency.

11. The method of claim 10 wherein computing at least one score for the at least one consumer comprises creating a composite score from the diffusion, participation, longevity, and recency scores.

12. The method of claim 1 wherein sending an invitation to participate in at least one marketing event comprises sending at least one invitation to participate in an artificial marketing event pertaining to a mock product or service.

13. The method of claim 1 wherein sending an invitation to participate in at least one marketing event comprises sending at least one marketing event invitation on a periodic basis.

14. The method of claim 1 wherein the at least one consumer comprises a group of more than one consumer, the method further comprising:
receiving an indication of a specific population within the group;
creating a consumer marketing panel based on the received indication of the specific population; and
outputting an identification of the consumer marketing panel to a third-party marketer.

15. The method of claim 1 wherein at least one of the at least one channel is selected from the group consisting of email, Internet websites, client-server applications, peer-to-peer applications, instant messages, telephony services, direct mail, interactive television, interactive kiosks, and human or computer-aided interviews.

16. The method of claim 1 further comprising outputting the at least one social networking score to a marketer for use in creating a consumer marketing panel after refining the at least one social networking score.

17. A system for identifying influential members of social groups, the system comprising:
an acquire server configured to:
collect consumer data from at least one consumer over at least one channel; and
analyze the collected consumer data for at least one social networking metric;
and
an event server with a scoring engine configured to:
compute at least one social networking score for the at least one consumer based at least in part on the collected consumer data; and
refine the at least one social networking score by sending at least one marketing event invitation to the at least one consumer.

18. The system of claim 17 wherein at least one of the at least one channel is selected from the group consisting of email, Internet websites, client-server applications, peer-to-peer applications, instant messages, telephony services, direct mail, interactive television, interactive kiosks, and human or computer-aided interviews.

19. The system of claim 17 wherein the scoring engine is configured to compute at least one score for each of the social networking metrics of diffusion, participation, longevity, and recency.

20. The system of claim 17 wherein the event server is further configured to output the at least one social networking score to a marketer for use in creating a consumer marketing panel after refining the at least one social networking score.
